(19) United States
(12) Patent Application Publication
(10) Pub. No.: US 2005/0065969 A1
(43) Pub. Date: Mar. 24, 2005

(54) Expressing sequence matching and alignment using SQL table functions

(76) Inventor: Shiby Thomas, Nashua, NH (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/916,434

(22) Filed: Aug. 12, 2004

Related U.S. Application Data
(60) Provisional application No. 60/498,698, filed on Aug. 29, 2003.

(51) Int. Cl. G06F 17/00

(52) U.S. Cl. 707/102

(57) ABSTRACT

An integrated solution in which BLAST functionality is integrated into a DBMS provides improved performance and scalability over the conventional approach, in addition to reducing the required hardware resources and reducing the cost of the system. In a database management system, a system for sequence matching and alignment comprises a database table storing sequence information comprising target sequences, a set of query sequences, and a table function operable to match the set of query sequences with target sequences stored in the database table, the table function having an interface including parameters.

### CROSS-REFERENCE TO RELATED APPLICATIONS

The benefit under 35 U.S.C. § 119(e) of provisional application 60/498,698, filed Aug. 29, 2003, is hereby claimed.

### FIELD OF THE INVENTION

The present invention relates to a table function and interface to the table function used for expressing sequence matching and alignment.

### BACKGROUND OF THE INVENTION

Genetic databases store vast quantities of data including nucleotide (gene) and amino acid (protein) sequences of different organisms. They assist molecular biologists in understanding the biochemical function, chemical structure and evolutionary history of organisms. An important aspect of managing today's exponential growth in genetic databases is the availability of efficient, accurate and selective techniques for detecting similarities between new and stored sequences.

The discovery of sequence homology to a known protein or family of proteins often provides the first clues about the function of a newly sequenced gene. As the DNA and amino acid sequence databases continue to grow in size they become increasingly useful in the analysis of newly sequenced genes and proteins because of the greater chance of finding such homologies.

There are a number of algorithms and software tools for searching sequence databases. All of them use some measure of similarity between sequences to distinguish biologically significant relationships from random similarities that occur by chance. The most studied measures are those used in conjunction with variations of the dynamic programming algorithm. These methods assign scores to insertions, deletions and replacements, and compute an alignment of two sequences that corresponds to the least costly set of such mutations. Such an alignment may be thought of as minimizing the evolutionary distance or maximizing the similarity between the two sequences compared. In either case, the cost of this alignment is a measure of similarity. Because of their computational requirements, dynamic programming algorithms are impractical for searching large databases without the use of a supercomputer or other special purpose hardware.

In order to allow searching large databases on commonly available computers, fast algorithms based on heuristics that attempt to approximate the above methods have been developed. In many heuristic methods the measure of similarity is not explicitly defined as a minimal cost set of mutations, but instead is implicit in the algorithm itself. For example, the FASTP program of Lipman and Pearson first finds locally similar regions between two sequences based on identities but not gaps, and then re-scores these regions using a measure of similarity between residues (a character in a sequence string is called a residue). Despite their rather indirect approximation of minimal evolution measures, heuristic tools such as FASTP have been quite popular and have identified many distant but biologically significant relationships.

Sequence similarity measures can generally be classified as either global or local. Global similarity algorithms optimize the overall alignment of two sequences, which may include large stretches of low similarity. Local similarity algorithms seek only relatively conserved subsequences, and a single comparison may yield several distinct subsequence alignments; unconserved regions do not contribute to the measure of similarity. Local similarity measures are generally preferred for database searches, where DNA sequences may be compared with partially sequenced genes, and where distantly related proteins may share only isolated regions of similarity.

Many similarity measures begin with a scoring matrix of similarity scores for all possible pairs of residues. Identities and conservative replacements have positive scores, while unlikely replacements have negative scores. A sequence segment is a contiguous stretch of residues of any length, and the similarity score for two aligned segments of the same length is the sum of the similarity values for each pair of aligned residues.

Basic Local Alignment Search Tool (BLAST) is another heuristic-based lgorithm for finding local alignments between sequences. In addition to being a fast algorithm compared to other similar algorithms, an important advantage of BLAST is that it provides a measure of statistical significance of the alignment scores with respect to an appropriate random sequence model. This allows the biologists to discard statistically insignificant alignments while detecting the significant ones fast. Hence BLAST has become a popular and widely used sequence alignment method.

Conventionally, many large genomic databases are implemented in conjunction with Database Management Systems (DBMSs). However, these genomic databases use the DBMS only as a storage repository. All the analysis and sequence alignments are done using external tools after exporting the data from the DBMS and transforming it into the appropriate formats accepted by the tools.

FIG. 1 shows a typical scenario in which an external BLAST server 102 is used in conjunction with sequence data stored in a DBMS 104. First, the relevant subset of the sequence database is selected and exported into a flat file 106. The BLAST server expects the data to be in a specific format. Therefore, a formatting tool 108 converts the sequence dataset to the required BLAST database format. After the BLAST search, the search results 110 need to be imported back into the database for storage and further analysis.

There are several problems that arise with the use of a conventional external BLAST server, as shown in FIG. 1. There are several steps in the process that require different skills. The movement of data back and forth poses a performance problem and limits the scalability of such a solution. Further, maintaining such a process requires additional hardware resources for running the database 104 as well as the external BLAST server 102. The performance problems and required additional hardware resources significantly increase the cost of this conventional approach.

A need arises for an integrated solution in which the BLAST functionality is integrated into a DBMS. This integrated solution would provide improved performance and scalability over the conventional approach, in addition to reducing the required hardware resources and reducing the cost of the system.

### SUMMARY OF THE INVENTION

The present invention is an integrated solution in which the BLAST functionality is integrated into a DBMS. This integrated solution would provide improved performance and scalability over the conventional approach, in addition to reducing the required hardware resources and reducing the cost of the system. A modern DBMS offers a wide range of data management and analytic functionality that may be advantageously used for bioinformatics applications.

Such a DBMS offers a scalable and efficient platform for storage and retrieval of genetic data. In one embodiment of the present invention, in a database management system, a system for sequence matching and alignment comprises a database table storing sequence information comprising target sequences, a set of query sequences, and a table function operable to match the set of query sequences with target sequences stored in the database table, the table function having an interface including parameters specifying at least some of: the set of query sequences; a cursor; a region of the query sequence to be used for a search; a type of translation for the table function to perform; a genetic code used for the translation; whether to mask off segments of the query sequence that have low compositional complexity; whether to filter out specified portions of the query sequences in the set of query sequences; a substitution matrix, which assigns a score for aligning pairs of residues; a statistical significance threshold for reporting matches against database sequences; a cost of opening a gap; a cost to extend a gap; a penalty for a nucleotide mismatch; a reward for a nucleotide match; a word size used for dividing the query sequence into subsequences during the search; a dropoff for BLAST extensions, an X dropoff value for gapped alignment; a fmal X dropoff value for gapped alignments in bits; a restriction of the database sequences to a number specified for which high-scoring segment pairs (HSPs) are reported; a sequence identifier of the query sequence; a sequence identifier of the returned match; a score of the returned match; an expect value of the returned match.

The table function may be either a match function operable to provide a sequence identification, score, and expect value of the match of a query sequence with a target sequence stored in the database table, or an alignment function operable to provide a full alignment of the query sequence with a target sequence stored in the database. The match function may be a separate function from the alignment function. The table function may be included in a FROM clause of a structured query language query. The table function may be operable to perform at least one of returning matches between a nucleotide query sequence and a nucleotide database, returning matches between an amino acid query sequence and an amino acid database, returning matches between a query sequence and database sequences involving a translation, returning alignments between a nucleotide query sequence and a nucleotide database, returning alignments between an amino acid query sequence and an amino acid database, and returning alignments between a query sequence and database sequences involving a translation. The translation may be at least one of comparing six-frame conceptual translation products of a nucleotide query sequence, both strands, against a protein sequence database, comparing a protein query sequence against a nucleotide sequence database dynamically translated in all six reading frames, both strands, and comparing six-frame translations of a nucleotide query sequence against six-frame translations of a nucleotide sequence database.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an illustration of a prior art external BLAST server used in conjunction with sequence data stored in a database management system (DBMS).

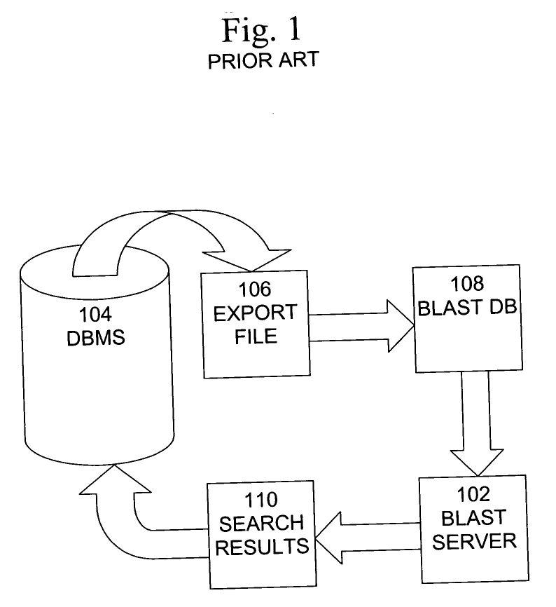

FIG. 2 is an exemplary flow diagram of a process for finding matching sequences in a genetic information database.

FIG. 3 is an exemplary data flow diagram of functional annotation performed using the system in which the present invention is implemented.

FIG. 4 is an exemplary block diagram of a database management system, in which the present invention may be implemented.

### DETAILED DESCRIPTION OF THE INVENTION

BLAST, developed by Altschul et al. in 1990, is a heuristic method to find the high scoring locally optimal alignments between a query sequence and a database [1]. BLAST focuses on no-gap alignments of a certain fixed length. The BLAST algorithm and family of programs rely on work on the statistics of un-gapped sequence alignments by Karlin and Altschul. The statistics allow the probability of obtaining an un-gapped alignment (also called MSP—Maximal Segment Pair) with a particular score to be estimated. The BLAST algorithm permits nearly all MSPs above a cutoff to be located efficiently in a database.

The algorithm operates in three steps:
1. For a given word length w (usually 3 for proteins and 11 for nucleotides) and a score matrix, a list of all words (w-mers) that can score greater than T (a score threshold), when compared to w-mers from the query is created.
2. The database is searched using the list of w-mers to find the corresponding w-mers in the database. These are called hits.
3. Each hit is extended to determine if an MSP that includes the w-mer scores greater than S, the preset threshold score for an MSP. Since pair score matrices typically include negative values, extension of the initial w-mer hit may increase or decrease the score. Accordingly, a parameter (the dropoff parameter in the interface) defines how large an extension will be tried in an attempt to raise the score above S.

A low value for T reduces the possibility of missing MSPs with the required S score, however lower T values also increase the size of the hit list generated in step 2 and hence the execution time and memory required. In practice, the values of T and S are chosen so as to balance the processor requirements and sensitivity.

BLAST is unlikely to be as sensitive for all protein searches as a full dynamic programming algorithm. However, the underlying statistics provide a direct estimate of the significance of any match found. The NCBI version of BLAST provides filters to exclude automatically regions of the query sequence that have low compositional complexity, or short periodicity internal repeats. The presence of such sequences can yield extremely large numbers of statistically significant but biologically uninteresting MSPs. For example, searching with a sequence that contains a long section of hydrophobic residues will find many proteins with transmembrane helices.

Like many other similarity measures, the MSP score for two sequences may be computed in time proportional to the product of their lengths using a simple dynamic programming algorithm. An important advantage of the MSP measure is that recent mathematical results allow the statistical significance of MSP scores to be estimated under an appropriate random sequence model. Furthermore, for any particular scoring matrix, one can estimate the frequencies of paired residues in maximal segments. This tractability to mathematical analysis is a crucial feature of the BLAST algorithm.

In searching a database of thousands of sequences, generally only a handful, if any, will be homologous to the query sequence. The scientist is therefore interested in identifying only those sequence entries with MSP scores over some cutoff score S. These sequences include those sharing highly significant similarity with the query as well as some sequences with borderline scores. This latter set of sequences may include high scoring random matches as well as sequences distantly related to the query. The biological significance of the high scoring sequences may be inferred solely on the basis of the similarity score, while the biological context of the borderline sequences may be helpful in distinguishing biologically interesting relationships.

The BLAST algorithm can be used to search nucleotide and amino acid query sequences against databases of nucleotide and amino acid sequences. Based on the nature of the query and the database sequences, the NCBI BLAST provides the following variants:
BLASTP compares an amino acid query sequence against a protein sequence database;
BLASTN compares a nucleotide query sequence against a nucleotide sequence database;
BLASTX compares the six-frame conceptual translation products of a nucleotide query sequence (both strands) against a protein sequence database;
TBLASTN compares a protein query sequence against a nucleotide sequence database dynamically translated in all six reading frames (both strands).
TBLASTX compares the six-frame translations of a nucleotide query sequence against the six-frame translations of a nucleotide sequence database.

Although this implementation of the BLAST algorithm is preferred, there are other implementations and variants of the BLAST algorithm that may be used advantageously by the present invention. Therefore, the present invention contemplates any and all implementations and variants of the BLAST algorithm.

In a preferred embodiment of the present invention, BLAST functionality may be implemented in a Relational Database Management System (RDBMS), such as the ORACLE® RDBMS. The features of this preferred embodiment may have wide application and are not limited to any particular RDBMS, or to relational database systems. Thus, it is clear that the present invention contemplates implementation on any database system, whether relational or non-relational.

A preferred embodiment of the present invention includes an API to the sequence similarity search functionality, which is a table function that can be used in the FROM clause of a SQL query. Table functions return virtual tables that can be manipulated just like regular tables [6]. Preferably, two families of functions are provided—the MATCH( ) family and the ALIGN( ) family. They accept the same set of input parameters. The MATCH( ) functions return only the sequence id, score and expect value of the target sequences in the database that have a high similarity with the query sequence. The ALIGN( ) functions return the full alignment of the query sequence with the target sequences. There are use cases in which BLAST is used as an initial screener for more complex alignment searches. In those cases, the result of the MATCH( ) function would be sufficient.

Example functions provided in a preferred embodiment include three MATCH( ) functions and three ALIGN( ) functions, as follows:
BLASTN_MATCH( ): Returns high scoring matches between a nucleotide query sequence and a nucleotide database.
BLASTP_MATCH( ): Returns high scoring matches between an amino acid query sequence and an amino acid database.
TBLAST_MATCH( ): Returns high scoring matches between a query sequence and database sequences involving translations. There are three types of translations—blastx, tblastn and tblastx.
BLASTN_ALIGN( ): Returns high scoring alignments between a nucleotide query sequence and a nucleotide database.
BLASTP_ALIGN( ): Returns high scoring alignments between an amino acid query sequence and an amino acid database.
TBLAST_ALIGN( ): Returns high scoring alignments between a query sequence and database sequences involving translations.
   1.1. BLASTN_MATCH( )

The purpose of this table function is to perform a BLASTN search of the given nucleotide sequence against the selected portion of the nucleotide database. The input query nucleotide sequence is specified as a character large object (CLOB). The database can be selected using a standard SQL select and passed into the function as a reference cursor. The reference cursor must have the schema (sequence_id VARCHAR2, sequence_data CLOB). The standard BLAST parameters that are described below are also accepted. The match returns the identifier of the matched (target) sequence (t_seq_id) (for example, the NCBI accession number), the score of the match, and the expect value.

function BLASTN_MATCH (

query_seq CLOB,
seqdb_cursor REF CURSOR,
subsequence_from NUMBER default null,
subsequence_to NUMBER default null,
filter_low_complexity BOOLEAN default false,
mask_lower_case BOOLEAN default false,
expect_value NUMBER default 10,
open_gap_cost NUMBER default 5,
extend_gap_cost NUMBER default 2,
mismatch_cost NUMBER default −3,
match_reward NUMBER default 1,
word_size NUMBER default 11,
dropoff NUMBER default 20,
final_x_dropoff NUMBER default 50)

return table of row (t_seq_id VARCHAR2,
score NUMBER, expect NUMBER)

1.2. BLASTP_MATCH( )

The purpose of this table function is to perform a BLASTP search of the given set of protein sequences against the portion of the protein database selected. The database can be selected using a standard SQL select and passed into the function as a cursor. The standard BLAST parameters that are described below are also accepted. The match returns the identifier of the query sequence (q_seq_id), the identifier of the matched (target) sequence (t_seq_id) (for example, the NCBI accession number), the score of the match, and the expect value.

function BLASTP_MATCH (

query_seq CLOB,
seqdb_cursor REF CURSOR,
subsequence_from NUMBER default null,
subsequence_to NUMBER default null,
filter_low_complexity BOOLEAN default false,
mask_lower_case BOOLEAN default false,
sub_matrix VARCHAR2 default ‘BLOSUM62’,
expect_value NUMBER default 10,
open_gap_cost NUMBER default 11,
extend_gap_cost NUMBER default 1,
word_size NUMBER default 3,
dropoff NUMBER default 7,
x_dropoff NUMBER default 15,
final_x_dropoff NUMBER default 25)

return table of row (t_seq_id VARCHAR2,
score NUMBER, expect NUMBER)

1.3. TBLAST_MATCH( )

The purpose of this table function is to perform BLAST searches involving translations of either the query sequence or the database of sequences. The available options are:
1. BLASTX: The query DNA sequence is translated and compared against a protein database.
2. TBLASTN: The query protein sequence is compared against a translated DNA database.
3. TBLASTX: The query sequence and the database sequence are both translated.

The database can be selected using a standard SQL select and passed into the function as a cursor. The standard BLAST parameters that are described below are also accepted. The match returns the identifier of the query sequence (q_seq_id), the identifier of the matched (target) sequence (t_seq_id) (for example, the NCBI accession number), the score of the match, and the expect value.

function TBLAST_MATCH (

query_seq CLOB,
seqdb_cursor REF CURSOR,
subsequence_from NUMBER default null,
subsequence_to NUMBER default null,
translation_type VARCHAR2 default ‘BLASTX’,
genetic_code VARCHAR2 default ‘universal’,
filter_low_complexity BOOLEAN default false,
mask_lower_case BOOLEAN default false,
sub_matrix VARCHAR2 default ‘BLOSUM62’,
expect_value NUMBER default 10,
open_gap_cost NUMBER default 11,
extend_gap_cost NUMBER default 1,
word_size NUMBER default 3,
dropoff NUMBER default 7,
x_dropoff NUMBER default 15,
final_x_dropoff NUMBER default 25)

return table of row (t_seq_id VARCHAR2,
score NUMBER, expect NUMBER)

1.4. BLASTN_ALIGN( )

The purpose of this table function is to perform a BLASTN alignment of the given nucleotide sequences against the portion of the nucleotide database selected. The database can be selected using a standard SQL select and passed into the function as a cursor. The standard BLAST parameters that are described below are also accepted. The BLASTN_MATCH( ) function returns only the score and expect value of the match. It does not return information about the alignment. The BLASTN_MATCH function will typically be used where the user wants to follow up a BLAST search with a full FASTA or Smith-Waterman alignment. The BLASTN_ALIGN( ) function does the BLAST alignment and returns the information about the alignment. The following attributes are returned:
q_se_id: identifier of the query sequence.
t_seq_id: identifier (for example, the NCBI accession number) of the matched (target) sequence
pct_identity: percentage of the query sequence that identically matches with the database sequence.
alignment_length: the length of the alignment
mismatches: number of base-pair mismatches between the query and the database sequence.
gap_openings: number of gaps opened in gapped alignment.
gap_list: list of offsets where a gap is opened.
q_start:
q_end: q_start and q_end correspond to the indices of the portion of the query sequence that is aligned.
s_start:
s_end: s_start and s_end correspond to the indices of the portion of the database sequence that is aligned.
expect: expect value of the alignment.

score: score corresponding to the alignment

function BLASTN_ALIGN (

query_seq CLOB,
seqdb_cursor REF CURSOR,
subsequence_from NUMBER default null,
subsequence_to NUMBER default null,
num_alignments NUMBER default 100,
filter_low_complexity BOOLEAN default false,
mask_lower_case BOOLEAN default false,
expect_value NUMBER default 10,
open_gap_cost NUMBER default 5,
extend_gap_cost NUMBER default 2,
mismatch_cost NUMBER default −3,
match_reward NUMBER default 1,
word_size NUMBER default 11,
dropoff NUMBER default 20,
final_x_dropoff NUMBER default 50)

return table of row (

t_seq_id VARCHAR2,
pct_identity NUMBER,
alignment_length NUMBER,
mismatches NUMBER,
gap_openings NUMBER,
gap_list [Table of NUMBER],
q_start NUMBER,
q_end NUMBER,
s_start NUMBER,
s_end NUMBER,
score NUMBER,
expect NUMBER)

1.5. BLASTP_ALIGN( )

The purpose of this table function is to perform a BLASTP alignment of the given protein sequences against the portion of the protein database selected. The database can be selected using a standard SQL select and passed into the function as a cursor. The standard BLAST parameters that are described below are also accepted. The BLASTP_MATCH( ) function returns only the score and expect value of the match. It does not return information about the alignment. The BLASTP_MATCH function will typically be used where the user wants to follow up a BLAST search with a full FASTA or Smith-Waterman alignment. The BLASTP_ALIGN( ) function does the BLAST alignment and returns the information about the alignment. The schema of the returned alignment is the same as that of BLASTN_ALIGN( ) .

function BLASTP_ALIGN (

query_seq CLOB,
seqdb_cursor REF CURSOR,
subsequence_from NUMBER default null,
subsequence_to NUMBER default null,
num_alignments NUMBER default 100,
filter_low_complexity BOOLEAN default false,
mask_lower_case BOOLEAN default false,
sub_matrix VARCHAR2 default ‘BLOSUM62’,
expect_value NUMBER default 10,
open_gap_cost NUMBER default 11,
extend_gap_cost NUMBER default 1,
word_size NUMBER default 3,
dropoff NUMBER default 7,
x_dropoff NUMBER default 15,
final_x_dropoff NUMBER default 25)

return table of row (

t_seq_id VARCHAR2,
pct_identity NUMBER,
alignment_length NUMBER,
mismatches NUMBER,
gap_openings NUMBER,
gap_list [Table of NUMBER],
q_start NUMBER,
q_end NUMBER,
s_start NUMBER,
s_end NUMBER,
score NUMBER,
expect NUMBER)

1.6. TBLAST_ALIGN( )

The purpose of this table function is to perform BLAST alignments involving translations of either the query sequence or the database of sequences. The available translation options are BLASTX, TBLASTN and TBLASTX. The schema of the returned alignment is the same as that of BLASTN_ALIGN( ) and BLASTP_ALIGN( ) .

function TBLAST_ALIGN (

query_seq CLOB,
seqdb_cursor REF CURSOR,
subsequence_from NUMBER default null,
subsequence_to NUMBER default null,
translation_type VARCHAR2 default ‘BLASTX’,
genetic_code VARCHAR2 default ‘universal’,
num_alignments NUMBER default 100,
filter_low_complexity BOOLEAN default false,
mask_lower_case BOOLEAN default false,
sub_matrix VARCHAR2 default ‘BLOSUM62’,
expect_value NUMBER default 10,
open_gap_cost NUMBER default 11,
extend_gap_cost NUMBER default 1,
word_size NUMBER default 3,
dropoff NUMBER default 7,
x_dropoff NUMBER default 15,
final_x_dropoff NUMBER default 25)

return table of row (

t_seq_id VARCHAR2,
pct_identity NUMBER,
alignment_length NUMBER,
mismatches NUMBER,
gap_openings NUMBER,
gap_list [Table of NUMBER],
q_start NUMBER,
q_end NUMBER,
s_start NUMBER,
s_end NUMBER,
score NUMBER,
expect NUMBER)

1.7. BLAST Parameters

Table 1 lists the input parameters to the BLAST functions with a short description. A detailed description of these parameters can be found in [3]. The MATCH( ) and ALIGN( ) functions accept the same set of input parameters.

TABLE 1
Parameter Descriptions

| Parameter | Description |
|---|---|
| query_seq(IN) | The query sequence supplied by the user for the |
| | search. The user specifies it as a bare sequence. |
| | A bare sequence is just lines of sequence data, |
| | without the FASTA definition line. Blank lines |
| | are not allowed in the middle of bare sequence |
| | input. |
| seqdb_cursor(IN) | The cursor parameter the user will supply when |
| | calling the function. It should return two |
| | columns in its returning row, the sequence |
| | identifier and the sequence string. |
| subsequence_from(IN) | The user can specify a region of the query |
| | sequence to be used for the search. This |
| | parameter specifies the start position of the |
| | subsequence to be used for the search. If the |
| | subsequence_from and subsequence_to are |
| | specified, it will be used for all sequences in the |
| | input collection. |
| subsequence_to(IN) | The user can specify a region of the query |
| | sequence to be used for the search. This |
| | parameter specifies the end position of the |
| | subsequence to be used for the search. |
| translation_type(IN) | This is the type of the translation involved. The |
| | options are BLASTX, TBLASTN and TBLASTX. |
| genetic_code(IN) | This is the genetic code used for the translation. |
| | NCBI BLAST supports 13 different genetic codes. |
| filter_low_complexity(IN) | If this parameter is set to TRUE, the search |
| | masks off segments of the query sequence that |
| | have low compositional complexity. Filtering |
| | can eliminate statistically significant but |
| | biologically uninteresting regions, leaving the |
| | more biologically interesting regions of the |
| | query sequence available for specific matching |
| | against database sequences. Filtering is only |
| | applied to the query sequence and will be |
| | applied to all the query sequences in the set. |
| mask_lower_case(IN) | If this parameter is set to TRUE, it is possible to |
| | specify a FASTA sequence in upper case |
| | characters as the query sequence, and denote |
| | areas to be filtered out with lower case. This |
| | allows to customize what is filtered from the |
| | sequence. This parameter will also be used for |
| | all query sequences in the set. |
| sub_matrix(IN) | This parameter specifies the substitution matrix, |
| | which assigns a score for aligning any possible |
| | pair of residues. The different options are |
| | PAM30, PAM70, BLOSUM80, BLOSUM62 |
| | and BLOSUM45. The default is BLOSUM62. |
| expect_value(IN) | This parameter specifies the statistical |
| | significance threshold for reporting matches |
| | against database sequences. The default value is |
| | 10. |
| open_gap_cost(IN) | This is the cost opening a gap. The default |
| | value is 5. |
| extend_gap_cost(IN) | The cost to extend a gap. The default value is 2 |
| mismatch_cost(IN) | The penalty for nucleotide mismatch. The |
| | default value is −3. |
| match_reward(IN) | The reward for a nucleotide match. The default |
| | value is 1. |
| word_size(IN) | The word size used for dividing the query |
| | sequence into subsequences during the search. |
| | The default value is 11. |
| dropoff(IN) | Dropoff for BLAST extensions in bits. The |
| | default value is 20. |
| x_dropoff(IN) | X dropoff value for gapped alignment in bits. |
| | The default value is 15. |
| final_x_dropoff(IN) | The final X dropoff value for gapped |
| | alignments in bits. The default value is 50. |
| num_alignments(IN) | This parameter restricts the database sequences |
| | to the number specified for which high-scoring |
| | segment pairs (HSPs) are reported. If more |
| | database sequences than this happen to satisfy |
| | the statistical significance threshold, only the |
| | alignments with the greatest statistical |
| | significance are reported. The default value of |
| | this parameter is 100. |
| t_seq_id(OUT) | The sequence identifier of the returned match. |
| score(OUT) | The score of the returned match. |
| expect(OUT) | The expect value of the returned match. |

The ALIGN( ) family of BLAST functions return the full alignment of the query sequence with the target sequence. The attributes of the ALIGN output and their descriptions are shown in Table 3. The output format is the same for all ALIGN( ) functions.

TABLE 2
ALIGN output attributes

| Attribute | Description |
|---|---|
| t_seq_id | The identifier (for example, the NCBI accession |
| | number) of the matched (target) sequence |
| pct_identity | Percentage of the query sequence that identically |
| | matches with the database sequence |
| alignment_length | Length of the alignment |
| mismatches | Number of base-pair mismatches between the query |
| | and the database sequence |
| gap_openings | number of gaps opened in gapped alignment. |
| gap_list | List of offsets where a gap is opened |
| q_start | q_start and q_end correspond to the indices of |
| q_end | the portion of the query sequence that is aligned |
| q_frame | Translation frame number if the query is |
| | translated |
| s_start | s_start and s_end correspond to the indices |
| s_end | of the portion of the database sequence that |
| | is aligned |
| s_frame | Translation frame number if the database |
| | sequence is translated |
| score | Score of the alignment |
| expect | Statistical significance measure of the |
| | alignment |

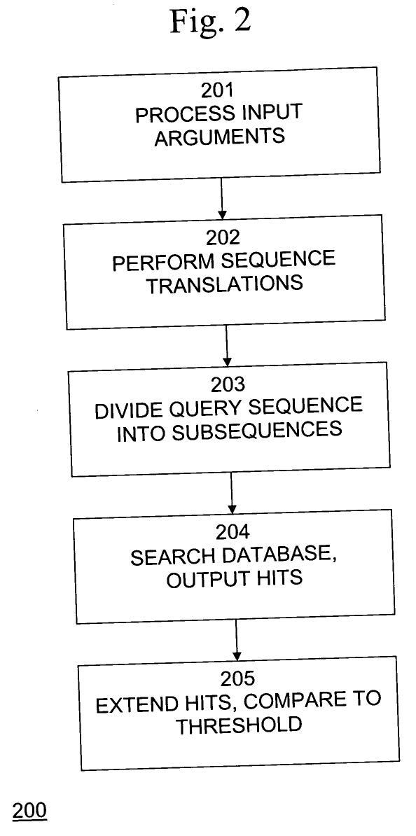

A process 200 for finding matching sequences in a genetic information database is shown in FIG. 2. Preferably, the query sequence is passed to the table functions as a character large object (CLOB). The database of sequences to be searched against is preferably passed as a reference cursor containing two columns, the sequence identifier and the sequence data. All the other parameters to the table functions are passed as scalar values, for example, as described above.

As an example of the processing performed, assume that the query sequence is “ATGCAGTACGTACGATCAGTACGT” and the database consists of two sequences; (1, “ATTCACTACTTACGATTGCAACGT”) and (2, “ATTCGGTATGCACGATCAGTACGT”). The major part of the processing involved in all six BLAST match and align functions is similar. Some functions have a few additional steps. For example, in TBLAST_MATCH and TBLAST_ALIGN, where there is translation involved, the sequences undergo the appropriate translations before the subsequent steps are performed. However, the steps shown in FIG. 2 are applicable to all BLAST match and align functions of the present invention.

Process 200 begins with step 201, in which the input arguments are processed and placed into a parameter object. Use of a parameter object is preferred as it is more compact this way to pass the arguments around to different functions. However, use of the parameter object is not necessary. Further, in typical use cases only a few arguments may be specified. For the arguments that are not specified, default values are substituted. An exemplary parameter object may include the following attributes.
Program_type: This attribute determines what function is being invoked. It is one of BLASTN_MATCH, BLASTP_MATCH, BLASTX_MATCH, TBLASTN_MATCH, TBLASTX_MATCH (the last three are different variations of TBLAST_MATCH), BLASTN_ALIGN, BLASTP_ALIGN, BLASTX_ALIGN, TBLASTN_ALIGN and TBLASTX_ALIGN.
Query_sequence: This attribute keeps the query sequence.
Seq_db_ref cursor: This is the reference cursor corresponding to the database of sequences.
Expect_value: This is the expectation value threshold. A default value of 10.0 is used if this argument is not specified.
Subsequence_from: The offset in the query sequence where the effective query subsequence starts.
Subsequence_to: The offset in the query sequence where the effective query subsequence ends.
Filter_low_complexity: If this attribute is set to TRUE, the search masks off segments of the query sequence that have low compositional complexity.
Open_gap_cost: The cost of opening a gap. If this argument is missing or if zero is passed, it is set to the default value. The default value is 5 for BLASTN and 11 for others.
Extend_gap_cost: The cost of extending a gap. If this argument is missing or if zero is passed, it is set to the default value. The default value is 2 for BLASTN and 1 for others.
Dropoff: Dropoff for BLAST extensions in bits. If this argument is missing or if zero is passed, it is set to the default value. The default value is 20 for BLASTN and 7 for others.
Final_x_dropoff: Dropoff value for final gapped alignments in bits. If this argument is missing or if zero is passed, it is set to the default value. The default value is 50 for BLASTN and 25 for others.
Mismatch_cost: Penalty for a nucleotide mismatch. This is applicable only to BLASTN. If this argument is missing, a default value of −3 will be used.
Match_reward: Reward for a nucleotide match. This is applicable only to BLASTN. If this argument is missing, a default value of 1 will be used.
Hit_extend_threshold: Threshold for extending hits. This parameter is not exposed to the user in this version. So, the default value of 15 will be used.
Perform_gapped_alignment: Set to TRUE by default. Gapped alignment is not available with TBLASTX.
Query_genetic_code: Genetic code to be used for the query sequences.
Db_genetic_code: Genetic code to be used for the database sequences.
Sub_matrix: The substitution matrix. If missing, default of “BLOSUM62” will be used.
Word_size: The word size used for dividing the query sequence into subsequences in Step-2. If this argument is missing or if zero is passed, it is set to the default value. The default value is 11 for BLASTN and 3 for others.
Db_length: The effective length of the database.
Mask_lower_case: Determines if lower case of filtering of FASTA sequences needs to be done. This is set to FLASE by default.
Multiple_hits_window_size: This is not exposed. The multiple hits algorithm is an optimization to the BLAST search.

The fully filled parameter object is the output of this step 201.

In step 202, the appropriate sequence translations are performed. The TBLAST_MATCH and TBLAST_ALIGN functions involve translation of nucleotide sequences into amino acid sequences. This translation is performed according to a genetic code. There are several different genetic codes that can be used for this translation. In a preferred embodiment, the “universal” genetic code is used. This code is also the default used by NCBI BLAST. There are 13 genetic codes supported in the present system. However, the present invention does contemplate using additional genetic codes.

DNA is a two-stranded molecule. Each strand is a polynucleotide composed of A (adenosine), T (thymidine), C (cytidine), and G (guanosine) residues. One strand of DNA holds the information that codes for various genes; this strand is often called the template strand or antisense strand (containing anticodons). The other, and complementary, strand is called the coding strand or sense strand (containing codons). Amino acid residues of proteins are specified as triplet codons. That is, a combination of 3 characters in a nucleotide sequence corresponds to an amino acid residue. Since DNA has a 4-letter alphabet, there are 64 possible combinations (4\hat{ }3=64). The mapping of these DNA residue combinations to the amino acid combinations is called a “genetic code”.

In the universal genetic code, 61 out of the 64 combinations correspond to an amino acid residue. The remaining 3 codons are used for “punctuation”; that is, they signal the termination (the end) of the growing polypeptide chain. The universal genetic code is shown below.

Aas = FLLSSSSYY**CC*WLLLLPPPPHHQQRRRRIIIMTTTTNNKKSSRRVVVVAAAADDEEGGGG
Base1 = TTTTTTTTTTTTTTTTCCCCCCCCCCCCCCCCAAAAAAAAAAAAAAAAGGGGGGGGGGGGGGGG
Base2 = TTTTCCCCAAAAGGGGTTTTCCCCAAAAGGGGTTTTCCCCAAAAGGGGTTTTCCCCAAAAGGGG
Base3 = TCAGTCAGTCAGTCAGTCAGTCAGTCAGTCAGTCAGTCAGTCAGTCAGTCAGTCAGTCAGTCAG

The top line corresponds to the amino acid residue and the other three lines correspond to the nucleotide bases. For example, TTT corresponds to F, TTA corresponds to L and GGG corresponds to G. The “*” in the top line corresponds to punctuation.

The input DNA sequence translated into an amino acid sequence according to the specified genetic code is output from this step 202.

In step 203, the query sequence is divided into a set of overlapping fixed length subsequences. For a given word length w (usually 3 for proteins) and scoring matrix, a list of all w-length subsequences (w-mers) that can score greater than a specified threshold T (a value of T=17 is used in NCBI BLAST), when compared to w-mers from the query, are created. For example, with w=3 the query sequence “ATGCAGTACGTACGATCAGTACGT” will first be split into subsequences, “ATG”, “TGC”, “GCA”, . . . etc. After the split, the subsequences that score less than T, when compared to the other w-mers from the query are dropped. The scoring is done according to a specified scoring matrix.

The wordlist with scores more than the specified threshold is output from this step 203.

In step 204, the database is searched using the list of high scoring w-mers found in the previous step 203, to find the corresponding w-mers in the database. The objective in this step is to identify for each query subsequence, the list of (sequence_id, offset) pairs in the database, where the query subsequence appears. In one embodiment, the entire database may be scanned in order to find the corresponding w-mers. In other embodiments, various forms of indexes may be used to speed up searching of the database.

The list of high scoring pairs is output from this step 204.

In step 205, each hit identified in step 204 is extended to determine if a Maximal Segment Pair (MSP) that includes the w-mer scores greater than S, the preset threshold score for an MSP. Since pair score matrices typically include negative values, extension of the initial w-mer hit may increase or decrease the score. Accordingly, a parameter defines how large an extension will be tried in an attempt to raise the score above S.

This step produces the score and expectation value for the high scoring hits, which is the output of process 200.

Usage examples of the BLAST family of table functions in which BLAST earches are combined with other database functionality are described below.

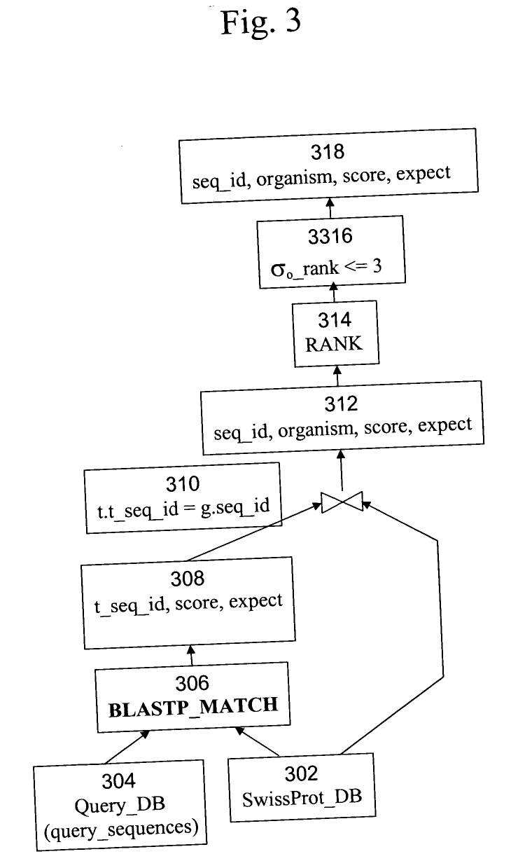

Functional annotation is the process of annotating newly discovered genes with descriptions about their potential functions. An example of functional annotation is shown in FIG. 3. Typically, the annotation is derived from the gene descriptor of most similar genes. In cases where the new gene is highly similar to several genes, any existing species hierarchy on the organism is used to organize the search results. By combining BLAST search and the analytic functions in the database, a single SQL query can be written to find the top three matches from each organism.

Assume that the table SwissProt_DB 302 consists of all the protein sequences in the SwissProt database and the table Query_DB 304 consists of the newly discovered fragments of the sequence to be searched for. The following query returns the top three matches in each organism. The BLASTP_MATCH table function 306 returns the sequence id, score and expect value 308 of the match. It is joined back with the SwissProt_DB table 302 on the sequence id 310 to get the organism attribute 312. The RANK function 314 partitions the result on the organism, sorts it in the descending order of score and computes a rank for each row 316 and outputs the results. An exemplary SQL query is shown below:

select t_seq_id, organism, score, expect
from (select t.t_seq_id, t.score, t.expect, g.organism,

RANK( ) OVER (PARTITION BY organism

ORDER BY score DESC) as o_rank

from SwissProt_DB g, Table(BLASTP_MATCH (

| | |
|---|---|
| (select | sequence |

from Query_DB
where seq_id = 1),
cursor (select seq_id, sequence

from SwissProt_DB))) t

where t.seq_id = g.seq_id)

where o_rank <= 3

Another exemplary use case of the present invention is drug discovery. In drug discovery, if the identified marker genes are newly found sequence fragments, similarity search is quite useful to identify potential leads. In this example, assume that the Inhibits (gene_id, inhibitor) table stores the relationship between genes and their inhibiting compounds and the compounds (compound_id, toxicity, . . . ) table stores information about the various compounds including their toxicity. The table Marker_Genes stores the sequence fragments that are used to query against the sequences stored in GENE_DB table. The following query selects three known sequences that are most similar to the query sequence and a list of non-toxic compounds that inhibit them.

select seq_id, compound_id
from inhibits, compounds,

(select t_seq_id as seq_id
from (select t.t_seq_id, t.score, t.expect,

from Table(BLASTN_MATCH (

(select sequence from Marker_Genes
where seq_id = 1),
cursor (select seq_id, sequence

from GENE_DB))) t

order by score)

where rownum <=3)

where inhibitor = compound_id AND seq_id = gene_id

AND toxicity = ‘NON_TOXIC’

Another exemplary use case of the present invention involves using the BLASTN_MATCH function. In this example, the table GENE_DB stores DNA sequences. GENE_DB has attributes (seq_id, publication date, modification date, organism, sequence) among other attributes. The following query does a BLAST search of the given query sequence against all human DNA sequences and returns the se_qid, score and expect value of matches that score >25. The schema of the table that stores the sequences is not required to be fixed. It is only required that it contains an identifier and the sequence and any number of other optional attributes.

select t.t_seq_id, t.score, t.expect
from Table(BLASTN_MATCH (

(select sequence from query_db),
cursor(select seq_id, sequence

from GENE_DB

where organism = ‘human’)) t

where t.score > 25;

The following query does the BLAST search against all sequences published after Jan. 1, 2000.

select t.t_seq_id, t.score, t.expect
from Table(BLASTN_MATCH (

(select sequence from query_db),
cursor(select seq_id, sequence

from GENE_DB

where publication_date > ‘01-JAN-2000))) t

where t.score > 25;

Other attributes of the matching sequence can be obtained by joining the BLAST result with the original sequence table as follows:

select t.t_seq_id, t.score, t.expect, g.publication_date, g.organism
from GENE_DB g, Table(BLASTN_MATCH (

(select sequence from query_db),
cursor(select seq_id, sequence

from GENE_DB

where publication_date > ‘01-JAN-2000))) t

where t.t_seq_id = g.seq_id AND t.score > 25;

In this approach, the portion of the database to be used for the search can be specified using SQL which is much more powerful than other search mechanisms like ENTREZ from NCBI. The full power of SQL can be used to perform more sophisticated functions.

Another exemplary use case of the present invention involves using the BLASTP_MATCH function. In this example, the table PROT_DB stores protein sequences. GENE_DB has attributes (identifier, name, publication date, modification date, organism, sequence) among other attributes. The following query does a BLASTP search of the given query sequence against all protein sequences and returns the identifier, score, name and expect value of matches that score >25.

select t.t_seq_id, t.score, t.expect, p.name
from PROT_DB p, Table(BLASTP_MATCH (

(select sequence from query_db),
cursor(select seq_id, sequence

from PROT_DB))) t

where t.t_seq_id = p.seq_id AND t.score > 25
order by t.expect;

Another exemplary use case of the present invention involves using the BLASTN_ALIGN function. In this example, the table GENE_DB stores DNA sequences. GENE_DB has attributes (seq_id, publication date, modification date, organism, sequence) among other attributes. The following query does a BLAST search and alignment of the given query sequence against all human DNA sequences and returns the publication_date, organism and the alignment attributes of matching sequences that score >25 and where more than 50% of the sequence is conserved in the match.

select t.t_seq_id, t.alignment_length, t.pct_identity, t.q_start,
t.q_end, t.s_start,
t.s_end, t.score, t.expect, g.publication_date, g.organism
from GENE_DB g, Table(BLASTN_ALIGN (

(select sequence from query_db),
cursor(select identifier, sequence

from GENE_DB

where publication_date > ‘01-JAN-2000))) t

where t.t_seq_id = g.identifier
AND t.score > 25
AND t.pct_identity > 50;

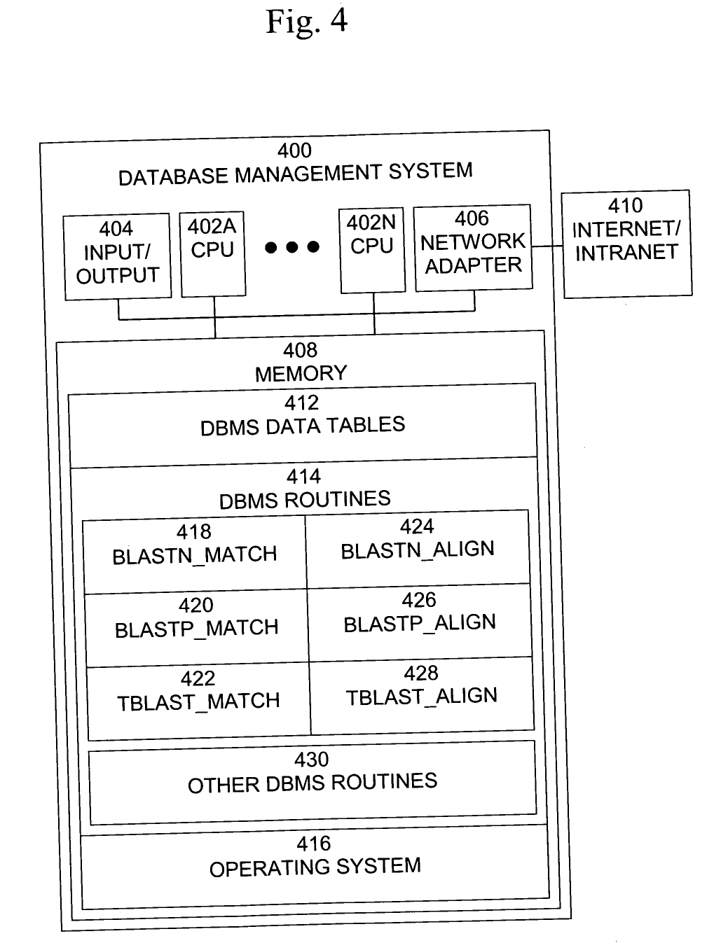

An exemplary block diagram of a database management system 400, in which the present invention may be implemented, is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which System 400 is implemented as a plurality of networked computer systems, which may be single-processor computer systems, multi-processor computer systems, or a mix thereof.

Input/output circuitry 404 provides the capability to input data to, or output data from, database/System 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces database/System 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 408 varies depending upon the function that system 400 is programmed to perform. In the example shown in FIG. 4, memory contents that would be included in Web server 106, search engine 108, and recommendation system 110 are shown. However, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 4, memory 408 includes database management system (DBMS) data 410, DBMS routines 412, and operating system 414. DBMS data 410 includes data structures, such as data tables, binary large object blocks (BLOBs), etc., that store data used by DBMS 400. Examples of such data include the genetic information that is to be searched, query sequences, etc. DBMS routines 414 include BLAST functions, such as BLASTN_MATCH function 418, BLASTP_MATCH function 420, TBLAST_MATCH function 422, BLASTN_ALIGN function 424, BLASTP_ALIGN function 426, TBLAST_ALIGN function 428, and other DBMS routines 430. Each BLAST function 418-428 performs BLAST processing as described above. Other DBMS routines 430 provide the functionality of DBMS in which the present invention is implemented, such as low-level database management functions, for example, those that perform accesses to the database and store or retrieve data in the database. Such functions are often termed queries and are performed by using a database query language, such as Structured Query Language (SQL). SQL is a standardized query language for requesting information from a database. The BLAST functions 418-428 are preferably implemented as SQL commands, and utilize the low-level database management functions provided by other DBMS routines 430. Operating system 428 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. In a database management system, a system for sequence matching and alignment comprising:
a database table storing sequence information comprising target sequences;
a set of query sequences; and
a table function operable to match the set of query sequences with target sequences stored in the database table, the table function having an interface including parameters specifying at least some of: the set of query sequences; a cursor; a region of the query sequence to be used for a search; a type of translation for the table function to perform; a genetic code used for the translation; whether to mask off segments of the query sequence that have low compositional complexity; whether to filter out specified portions of the query sequences in the set of query sequences; a substitution matrix, which assigns a score for aligning pairs of residues; a statistical significance threshold for reporting matches against database sequences; a cost of opening a gap; a cost to extend a gap; a penalty for a nucleotide mismatch; a reward for a nucleotide match; a word size used for dividing the query sequence into subsequences during the search; a dropoff for BLAST extensions, an X dropoff value for gapped alignment; a fmal X dropoff value for gapped alignments in bits; a restriction of the database sequences to a number specified for which high-scoring segment pairs (HSPs) are reported; a sequence identifier of the query sequence; a sequence identifier of the returned match; a score of the returned match; and an expect value of the returned match.

2. The system of claim 1, wherein the table function is either a match function operable to provide a sequence identification, score, and expect value of a match of a query sequence with a target sequence stored in the database table, or an alignment function operable to provide a full alignment of the query sequence with a target sequence stored in the database.

3. The system of claim 2, wherein the match function is a separate function from the alignment function.

4. The system of claim 3, wherein the table function is included in a FROM clause of a structured query language query.

5. The system of claim 1, wherein the table function is operable to perform at least one of:
returning matches between a nucleotide query sequence and a nucleotide database;
returning matches between an amino acid query sequence and an amino acid database;
returning matches between a query sequence and database sequences involving a translation;
returning alignments between a nucleotide query sequence and a nucleotide database;
returning alignments between an amino acid query sequence and an amino acid database; and
returning alignments between a query sequence and database sequences involving a translation.

6. The system of claim 5, wherein the translation is at least one of:
comparing six-frame conceptual translation products of a nucleotide query sequence, both strands, against a protein sequence database;
comparing a protein query sequence against a nucleotide sequence database dynamically translated in all six reading frames, both strands; and
comparing six-frame translations of a nucleotide query sequence against six-frame translations of a nucleotide sequence database.

7. In a database management system, an interface for a table function for sequence matching and alignment comprising:
a plurality of parameters specifying at least some of: the set of query sequences; a cursor; a region of the query sequence to be used for a search; a type of translation for the table function to perform; a genetic code used for the translation; whether to mask off segments of the query sequence that have low compositional complexity; whether to filter out specified portions of the query sequences in the set of query sequences; a substitution matrix, which assigns a score for aligning pairs of residues; a statistical significance threshold for reporting matches against database sequences; a cost of opening a gap; a cost to extend a gap; a penalty for a nucleotide mismatch; a reward for a nucleotide match; a word size used for dividing the query sequence into subsequences during the search; a dropoff for BLAST extensions, an X dropoff value for gapped alignment; a final X dropoff value for gapped alignments in bits; a restriction of the database sequences to a number specified for which high-scoring segment pairs (HSPs) are reported; a sequence identifier of the query sequence; a sequence identifier of the returned match; a score of the returned match; and an expect value of the returned match.

8. The interface of claim 7, wherein the table function is either a match function operable to provide a sequence identification, score, and expect value of a query sequence with a target sequence stored in the database table, or an alignment function operable to provide a full alignment of the query sequence with a target sequence stored in the database.

9. The interface of claim 8, wherein the match function is a separate function from the alignment function.

10. The interface of claim 9, wherein the table function is included in a FROM clause of a structured query language query.

11. The interface of claim 7, wherein the table function is operable to perform at least one of:
returning matches between a nucleotide query sequence and a nucleotide database;
returning matches between an amino acid query sequence and an amino acid database;
returning matches between a query sequence and database sequences involving a translation;
returning alignments between a nucleotide query sequence and a nucleotide database;
returning alignments between an amino acid query sequence and an amino acid database; and
returning alignments between a query sequence and database sequences involving a translation.

12. The interface of claim 11, wherein the translation is at least one of:
comparing six-frame conceptual translation products of a nucleotide query sequence, both strands, against a protein sequence database;
comparing a protein query sequence against a nucleotide sequence database dynamically translated in all six reading frames, both strands; and
comparing six-frame translations of a nucleotide query sequence against six-frame translations of a nucleotide sequence database.
